(19) United States
(12) Patent Application Publication
(10) Pub. No.: US 2024/0322163 A1
(43) Pub. Date: Sep. 26, 2024

(54) SOLID-STATE BATTERY

(71) Applicant: SAMSUNG ELECTRO-MECHANICS CO., LTD., Gyeonggi-do (KR)

(72) Inventors: Kyung-Lock Kim, Suwon-si, Gyeonggi-do (KR); Myung-Jin Jung, Suwon-si, Gyeonggi-do (KR); Young-Jin Hwang, Suwon-si, Gyeonggi-do (KR); Jeong-Wook Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/275,079

(22) PCT Filed: Jan. 20, 2022
(86) PCT No.: PCT/KR2022/001047

§ 371 Date: Jul. 31, 2023

(30) Foreign Application Priority Data
Oct. 6, 2021 (KR) 10-2021-0132640

(51) Int. Cl. H01M 4/58; H01M 4/02; H01M 4/136; H01M 10/0562

(52) U.S. Cl. CPC H01M 4/5825; H01M 4/136; H01M 10/0562; H01M 2004/021; H01M 2004/027; H01M 2004/028; H01M 2300/0068

(57) ABSTRACT

A solid-state battery includes a battery body including first and second surfaces opposing in a first direction of the battery body, and having a positive electrode layer including a positive electrode current collector and a positive electrode active material layer, a solid electrolyte layer, and a negative electrode layer including a negative electrode current collector and a negative electrode active material layer; a positive terminal connected to the positive electrode layer and disposed on the first surface of the battery body; and a negative terminal connected to the negative electrode layer and disposed on the second surface of the battery body. The positive active material layer includes lithium cobalt phosphate (LCP). The solid electrolyte layer includes a lithium aluminum germanium phosphate (LAGP) solid electrolyte represented as Li₁₊ₓ AlₓGe₂₋ₓ(PO₄)₃(O<x<1). The positive electrode active material layer includes at least one or more of lithium germanium phosphate (LGP) and lithium tin phosphate (LSP).

### TECHNICAL FIELD

Example embodiments of the present disclosure relate to a solid-state battery.

### BACKGROUND ART

Recently, devices using electricity as an energy source have increased. As devices within various fields using electricity, such as smartphones, camcorders, notebook PCs, and electric vehicles, have increased, there has been increasing interest in electrical storage devices using electrochemical devices. Among various electrochemical devices, a lithium secondary battery which may be charged and discharged, may have a high operating voltage, and may have an extremely high energy density has increasingly been used.

A lithium secondary battery may be manufactured by applying a material for inserting and deintercalating lithium ions to a positive electrode and a negative electrode and injecting a liquid electrolyte into a region between the positive electrode and the negative electrode, and electricity may be generated or consumed by redox reaction, according to injection or deintercalation of lithium ions in the negative electrode and the positive electrode. Such a lithium secondary battery should be stable within the operating voltage range of the battery, and should have performance for transferring ions at a sufficiently high speed.

When a liquid electrolyte such as a non-aqueous electrolyte is used for such a lithium secondary battery, discharge capacity and energy density may be relatively high. However, it may be difficult for a lithium secondary battery to implement a high voltage, and there may be a high risk of electrolyte leakage, fire, and explosion.

To address the above issues, a secondary battery to which a solid electrolyte is applied instead of a liquid electrolyte has been suggested as an alternative. A solid electrolyte may include a polymer-based solid electrolyte and a ceramic-based solid electrolyte, and a ceramic-based solid electrolyte may have high stability. However, stability of a charge-discharge cycle may be low, and it may be difficult to implement a high-output and high-capacity product.

### DISCLOSURE OF INVENTION

### Technical Problem

An example embodiment of the present disclosure is to provide a solid-state battery having excellent stability in a charge-discharge cycle.

An example embodiment of the present disclosure is to provide a solid-state battery having a high operating voltage.

An example embodiment of the present disclosure is to provide a solid-state battery having improved long-term reliability.

### Solution to Problem

According to an example embodiment of the present disclosure, a solid-state battery includes a battery body including first and second surfaces opposing in a first direction of the battery body, third and fourth surfaces opposing in a second direction of the battery body, and fifth and sixth surfaces opposing in a third direction of the battery body, and having a positive electrode layer including a positive electrode current collector and a positive electrode active material layer, a solid electrolyte layer, and a negative electrode layer including a negative electrode current collector and a negative electrode active material layer; a positive terminal connected to the positive electrode layer and disposed on the first surface of the battery body; and a negative terminal connected to the negative electrode layer and disposed on the second surface of the battery body. The positive active material layer includes lithium cobalt phosphate (LCP). The solid electrolyte layer includes a lithium aluminum germanium phosphate (LAGP) solid electrolyte represented as Li₁₊ₓAlₓGe₂₋ₓ(PO₄) (0<x<1). The negative electrode active material layer includes at least one or more of lithium germanium phosphate (LGP) and lithium tin phosphate (LSP).

According to an example embodiment of the present disclosure, a solid-state battery includes a battery body including first and second surfaces opposing in a first direction of the battery body, third and fourth surfaces opposing in a second direction of the battery body, and fifth and sixth surfaces opposing in a third direction of the battery body, and having a positive electrode layer including a positive electrode current collector and a positive electrode active material layer, a solid electrolyte layer, and a negative electrode layer including a negative electrode current collector and a negative electrode active material layer; a positive terminal connected to the positive electrode layer and disposed on the first surface of the battery body; and a negative terminal connected to the negative electrode layer and disposed on the second surface of the battery body. The positive active material layer includes lithium cobalt phosphate (LCP). An operating voltage of the solid-state battery is 3.5 V or higher.

According to an example embodiment of the present disclosure, a solid-state battery includes a battery body including a positive electrode layer including a positive electrode current collector and a positive electrode active material layer, a negative electrode layer including a negative electrode current collector and a negative electrode active material layer, and a solid electrolyte layer disposed between the positive electrode layer and the negative electrode layer: a positive terminal disposed on the battery body and connected to the positive electrode layer; and a negative terminal disposed on the battery body and connected to the negative electrode layer. The solid electrolyte layer includes a lithium aluminum germanium phosphate (LAGP) solid electrolyte represented as Li₁₊ₓAlₓGe₂₋ₓ(PO₄)₃(0<x<1). The negative electrode active material layer includes at least one or more of lithium germanium phosphate (LGP) and lithium tin phosphate (LSP).

### Advantageous Effects of Invention

According to example embodiments of the present disclosure, it is possible to provide a solid-state battery having excellent stability in a charge-discharge cycle.

According to example embodiments of the present disclosure, it is possible to provide a solid-state battery having a high operating voltage.

According to example embodiments of the present disclosure, it is possible to provide a solid-state battery having improved long-term reliability.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a solid-state battery according to an example embodiment of the present disclosure;

FIG. 2 is a perspective diagram illustrating the battery body in FIG. 1;

FIG. 3 is a cross-sectional diagram taken along line I-I′ in FIG. 1;

FIG. 4 is an enlarged diagram illustrating region A in FIG. 3;

FIG. 5 is an enlarged diagram illustrating region B in FIG. 3;

FIG. 6 is a perspective diagram illustrating a battery body according to another example embodiment of the present disclosure;

FIG. 7 is a perspective diagram illustrating the battery body in FIG. 6;

FIG. 8 is a cross-sectional diagram taken along line 11-11′ in FIG. 6;

FIG. 9 is an enlarged diagram illustrating region C in FIG. 8; and

FIG. 10 is an enlarged diagram illustrating region D in FIG. 8.

### MODE FOR THE INVENTION

Hereinafter, embodiments of the present disclosure will be described as follows with reference to the accompanying drawings.

It is to be understood that the terms or words used in this description and the following claims should not be construed as having meanings which are general or may be found in a dictionary. Therefore, considering the principle that an inventor may most properly define the concepts of the terms or words to best explain his or her invention, the terms or words must be understood as having meanings or concepts that conform to the technical spirit of the present disclosure. Also, since the example embodiments set forth herein and the configurations illustrated in the drawings are nothing but examples and are not representative of all of the technical spirit of the present disclosure, it is to be understood that various equivalents and modifications may replace the example embodiments and configurations at the time of the present application.

In the drawings, the same elements will be indicated by the same reference numerals. Also, redundant descriptions and detailed descriptions of known functions and elements that may unnecessarily render the gist of the present disclosure obscure will be omitted. In the accompanying drawings, some elements may be exaggerated, omitted or briefly illustrated, and the sites of the elements do not necessarily reflect the actual sizes of these elements.

The terms. “include,” “comprise.” “is configured to,” etc. of the description are used to indicate the presence of features, numbers, steps, operations, elements, portions or combination thereof, and do not exclude the possibilities of combination or addition of one or more features, numbers, steps, operations, elements, portions or combination thereof.

The term “and/or” includes a combination of a plurality of described relevant items or any item of a plurality of described relevant items.

In the example embodiments, the X direction may be defined as a first direction, an L direction or a length direction, a Y direction may be defined as a second direction, a W direction or a width direction, and the Z direction may be defined as a third direction, a T direction, or a thickness direction.

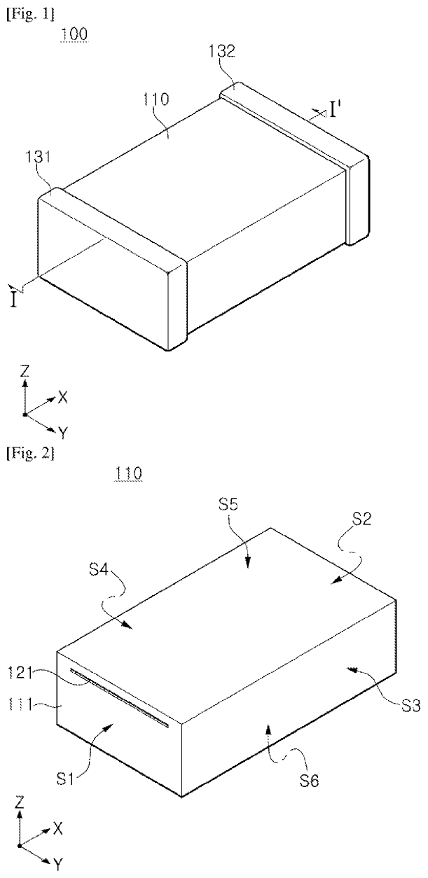

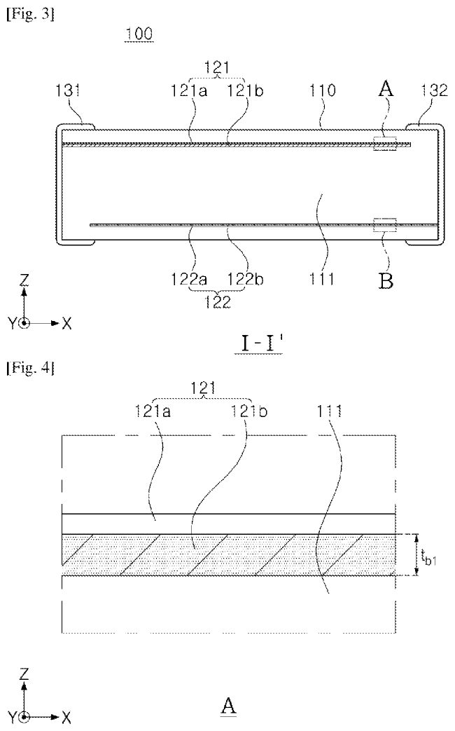

The example embodiment relates to a solid-state battery 100. FIGS. 1 to 5 are diagrams illustrating a solid-state battery 100 according to an example embodiment. Referring to FIGS. 1 to 5, a solid-state battery 100 in the example embodiment may include first and second surfaces opposing in the first direction, third and fourth surfaces opposing in the second direction, and fifth and sixth surfaces opposing in the third direction, and including a positive electrode layer 121 including a positive electrode current collector 121a and a positive electrode active material layer 121b including lithium cobalt phosphate (LCP), a negative electrode layer 122 including a negative electrode current collector 122a and a negative electrode active material layer 122b, a solid electrolyte layer 111, a positive terminal 131 connected to the positive electrode layer 121 and disposed on the first surface of the battery body 110, and a negative terminal 132 connected to the negative electrode layer 122 and disposed on the second surface of the battery body 110.

The solid-state battery 100 in the example embodiment may have an operating voltage of 3.5 V or higher. The operating voltage may refer to, for example, a difference between operating potentials of a positive electrode and a negative electrode. Recently, solid-state batteries have replaced general secondary batteries in various fields. However, since solid-state batteries may be vulnerable to deformation a shape such as a volume due to properties of solid electrolyte, component such as a positive active material, a negative electrode active material and electrolyte which may prevent the shape deformation may be selected, such that it may be difficult to implement a high operating voltage. However, in the solid-state battery 100 in the example embodiment, the positive electrode active material layer 121b containing lithium cobalt phosphate (LCP) may be applied, such that the solid-state battery 100 having a high operating voltage of 3.5 V or more may be implemented. The operating voltage may be 3.5 V or more, 3.6 V or more, 3.7 V or more, or 3.8 V or more, and an upper limit thereof may not be limited to any particular example, and may be, for example, 5.2 V or less.

The body 110 of the solid-state battery 100 in the example embodiment may include the solid electrolyte layer 111, the positive electrode layer 121, and the negative electrode layer 122. The positive electrode layer 121 and the negative electrode layer 122 may be disposed to oppose each other in the third direction with the solid electrolyte layer 111 interposed therebetween.

The positive electrode layer 121 of the solid-state battery 100 in the example embodiment may include the positive electrode active material layer 121b and the positive electrode current collector 121a. FIG. 4 is an enlarged diagram illustrating a portion of the positive electrode layer 121 of the solid-state battery 100 in the example embodiment. Referring to FIG. 4, the positive electrode layer 121 in the example embodiment may include the positive electrode active material layer 121b and the positive electrode current collector 121a, and for example, the positive electrode active material layer 121b and the positive electrode current collector 121a may be attached to each other.

The negative electrode active material layer 121b of the solid-state battery 100 in the example embodiment may include a negative electrode active material having an olivine crystal structure. In the olivine-type positive electrode active material, lithium ions and transition metal ions may occupy each half of the octahedral sites, and the octahedral and tetrahedral structures forming the crystal structure may share edges and may accordingly have a diffusion path of lithium ion, such that the diffusion rate of lithium ions may increase. Also, since the positive electrode active material having an olivine-type crystal structure has a high redox potential, the solid-state battery 100 in the example embodiment may implement a high operating voltage including the positive electrode active material having the olivine-type crystal structure. The olivine-type crystal structure may be observed through XRD analysis.

In the example embodiment, the positive active material of the solid-state battery 100 having an olivine crystal structure in the example embodiment may include lithium transition metal phosphate, and may include lithium cobalt phosphate (LCP), for example. Lithium transition metal phosphate having the olivine-type crystal structure may have a high potential and excellent stability, and may have a high theoretical density, thereby improving capacity of the solid-state battery 100.

In an example embodiment, lithium cobalt phosphate (LCP) of the solid-state battery 100 in the example embodiment may include LiCoPO₄. Lithium cobalt phosphate (LCP) used as a positive electrode active material may include Li₂CoP₂O₇ in addition to LiCoPO₄ but since LiCoPO₄ has a higher theoretical density than Li₂CoP₂O₇, when LiCoPO₄ is included as a positive electrode active material, the solid-state battery 100 having high capacity may be implemented.

The positive active material layer 121b of the solid-state battery 100 in the example embodiment may selectively include a conductive material and/or a binder if desired. The conductive material is not limited to any particular material as long as the material has conductivity without causing a chemical change in the solid-state battery 100 in the example embodiment. For example, graphite such as natural graphite and artificial graphite; carbon-based substances such as carbon black, acetylene black, ketjen black, channel black, furnace black, lamp black, and summer black; conductive fibers such as carbon fibers and metal fibers: carbon fluoride; metal powders such as aluminum and nickel powder; conductive whiskers such as zinc oxide and potassium titanate; a conductive metal oxide such as titanium oxide; conductive materials such as polyphenylene derivatives may be used.

The binder may be used to improve bonding strength between the active material and the conductive agent. As the binder, polyvinylidene fluoride, polyvinyl alcohol, carboxymethyl cellulose (CMC), starch, hydroxypropyl cellulose, regenerated cellulose, polyvinyl pyrrolidone, polytetratluoroethylene, polyethylene, polypropylene, ethylenepropylene-dieneterpolymer (EPDNM), sulfonated EPDM, styrene butadiene rubber, fluororubber, and various copolymers may be used, but an example embodiment thereof is not limited thereto.

In another example in the example embodiment, the positive active material layer 121b of the solid-state battery 100 may further include a solid electrolyte component if desired. As the solid electrolyte component, one or more of the components described later may be used, and the solid electrolyte component may function as an ion conduction channel in the positive electrode active material layer 121b. Accordingly, interface resistance may be reduced.

In an example embodiment, an average thickness of the positive electrode active material layer 121b of the solid-state battery 100 in the example embodiment may be 5.0 μm or less. In the example embodiment. “thickness” of a member may refer to the shortest vertical distance measured in a direction parallel to the third direction, and “average thickness” may refer to an arithmetic average of thicknesses measured at 10 places. The thickness may be values measured at 10 points with the same distance therebetween in the first direction with respect to the positive electrode active material layer 121b the most adjacent to the center of the solid-state battery 100 on the cross-sectional surface (XZ plane) crossing the center of the solid-state battery 100 and cut out in the direction perpendicular to the Y axis. The average thickness of the positive active material layer 121b may be 5.0 cm or less, 4.8 μm or less, 4.6 μm or less, 4.4 μm or less, 4.2 pin or less, or 4.0 μm or less, but an example embodiment thereof is not limited thereto. A lower limit of the average thickness of the positive active material layer 121b is not limited to any particular example, and may be, for example, 0.5 μm or more.

The positive electrode layer 121 of the solid-state battery 100 in the example embodiment may include the positive electrode current collector 121a together with the positive electrode active material layer 121b. A porous body such as a mesh or mesh shape may be used as the positive electrode current collector 121a, and a porous metal plate such as stainless steel, silver, nickel, aluminum, copper, palladium, and a palladium alloy may be used, but an example embodiment thereof is not limited thereto. Also, the positive electrode current collector 121a may include the same component as the aforementioned conductive material. For example, the positive electrode current collector 121a may include graphite such as natural graphite or artificial graphite; carbon-based substances such as carbon black, acetylene black, ketjen black, channel black, furnace black, lamp black, and summer black; conductive fibers such as carbon fibers and metal fibers; carbon fluoride; conductive whiskers such as zinc oxide and potassium titanate; conductive metal oxides such as titanium oxide; a conductive material, such as a polyphenylene derivative, but an example embodiment thereof is not limited thereto. Also, the positive electrode current collector 121a may be coaled with an oxidation-resistant metal or an alloy film to prevent oxidation.

The method of forming the positive electrode layer 121 is not limited to any particular example, and for example, a slurry may be formed by mixing the above-described positive electrode active material, a conductive material (additionally including the solid electrolyte layer 111 if desired) and a binder, and the positive electrode layer 121 may be formed by casting the slurry on the positive electrode current collector 121a and curing the slurry.

The solid electrolyte layer 111 may be disposed between the positive electrode layer 121 and the negative electrode layer 122 of the solid-state battery 100 in the example embodiment. The solid electrolyte layer 11 may include a solid electrolyte component, and the solid electrolyte component may be, for example, a NASICON-type solid electrolyte. Specifically, NASICON-type solid electrolyte may be, for example, a phosphate-based solid electrolyte having a NASICON structure, and more specifically, phosphate-based solid electrolyte having a NASICON structure may refer to Li₁₊ₓAlₓM₂₋ₓ(PO₄)₃(LAMP) (0<x<2, M=Zr, Ti, Ge) based compound, but an example embodiment thereof is not limited thereto. When solid electrolyte of the solid-state battery 100 in the example embodiment includes a phosphate-based solid electrolyte having a NASICON structure, high conductivity and excellent stability may be secured.

In an example embodiment, phosphate-based solid electrolyte having a NASICON structure of the solid-state battery 100 in the example embodiment may be lithium aluminum germanium phosphate (LAGP) solid electrolyte represented as Li₁₊ₓAlₓGe₂₋ₓ(PO₄)₃(0<x<1). LAGP solid electrolyte may have various compositions depending on the value of x. For example, when x=0.5, the LAGP solid electrolyte may be a component represented as Li_{1.5}Al_{0.5}Ge_{1.5}(PO₄)₃, When solid electrolyte of the solid-state battery 100 in the example embodiment includes LAGP solid electrolyte, it is elution of the transition metal of the positive active material having the above-described olivine-type crystal structure into electrolyte may be prevented, thereby the solid-state battery 100 having excellent reliability.

In an example embodiment, the average thickness of the solid electrolyte layer 111 of the solid-state battery 100 in the example embodiment may be in the range of 3 μm to 30 μm. The average thickness of the solid electrolyte layer 111 may be measured by the same method as the above-described method for measuring the average thickness of the positive electrode active material layer 121b. The average thickness of the solid electrolyte layer 1l1 may be 3.0 μm or more, 3.5 μm or more. 4.0 μm or more, 4.5 μm or more, or 5.0 μm or more, or may be 30.0 μm or less, 27.5 μm or less, 25.0 μm or less, 22.5 μm or less, or 20.0 μm or less, but an example embodiment thereof is not limited thereto. When the average thickness of the all-solid solid electrolyte layer 111 in the example embodiment satisfies the above range, current capacity of the solid-state battery 100 may increase such that duration may improve.

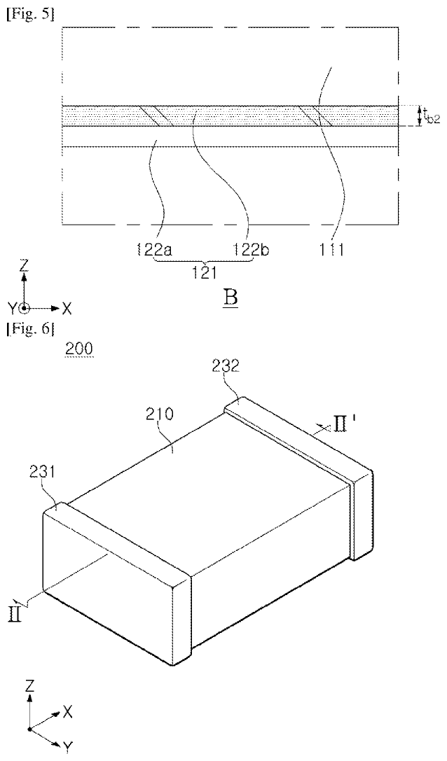

The negative electrode layer 122 of the solid-state battery 100 in the example embodiment may include a negative electrode active material layer 122b and a negative electrode current collector 122a. FIG. 5 is an enlarged diagram illustrating a portion of the negative electrode layer 122 of the solid-state battery 100 according to the example embodiment. Referring to FIG. 5, the negative electrode layer 122 in the example embodiment may include the negative electrode active material layer 122b and the negative electrode current collector 122a, and for example, the negative electrode active material layer 122b and the negative electrode current collector 122a may be attached to each other.

The negative electrode active material layer 122b of the solid-state battery 100 in the example embodiment may include a positive electrode active material for forming an alloy with lithium. The negative active material for forming an alloy with lithium may include one or more components selected from among Al, Zn. Si, Sn, Ge, Cd, Pb. Bi, and Sb. When the positive electrode active material of the solid-state battery 100 in the example embodiment includes a component for forming an alloy with lithium, high energy density may be obtained, thereby implementing the solid-state battery 100 having high capacity.

In an example embodiment, the negative active material of the solid-state battery 100 in the example embodiment may have an operating potential of 1.5 V or less. The operating potential of the negative active material may refer to an electrochemical equilibrium potential based on lithium, and may refer to an equilibrium potential of when the potential at which the lithium metal reaches electrochemical equilibrium in the electrolyte is 0 V, for example. The operating potential of the negative active material may be 1.5 V (vs. Li/Li+) or less, 1.4 V (vs. Li/Li+) or less. 1.3 V (vs. Li/Li+) or less, 1.2 V (vs. Li/Li+) or less. 1.1 V (vs. Li/Li+) or less or 1.0 V (vs. Li/Li+) or less, but an example embodiment thereof is not limited thereto. A lower limit of the operating potential of the negative active material is not limited to any particular example, and may be, for example, 0 V (vs. Li/Li+) or more based on Li metal. When the operating potential of the negative active material according to the example embodiment satisfies the above range, a high operating voltage may be implemented.

In an example embodiment, the negative active material of the solid-state battery 100 in the example embodiment may include one or more of lithium germanium phosphate (LGP) and lithium tin phosphate (LSP). Lithium germanium phosphate (LGP) may include a component represented as LiGe₂(PO₂)₃, and lithium tin phosphate (LSP) may include a component represented as LiSn₂(PO₄)₃. Lithium germanium phosphate (LGP) and lithium tin phosphate (LSP) may form a Li—PO₃ matrix in the structure, and may form an alloy with lithium during charging such that volume expansion of the negative electrode may be prevented, and accordingly, high stability may be obtained with respect to charge-discharge cycles.

In the solid-state battery 100 in another example embodiment, the positive electrode active material layer 121b containing lithium cobalt phosphate (LCP) may be applied, such that the solid-state battery 100 having a high operating voltage of 3.5 V or more may be implemented, and solid electrolyte may contain LAGP solid electrolyte described above such that elution of transition metal into the electrolyte may be prevented, thereby obtaining excellent reliability, and also, lithium germanium phosphate (LGP) and lithium tin phosphate (LSP) may form the Li—PO₃ matrix in the structure, and may form an alloy with lithium during charging such that volume expansion of the positive electrode may be prevented, and accordingly, high stability may be obtained with respect to charge-discharge cycles.

The negative electrode active material layer 122b of the solid-state battery 100 in the example embodiment may selectively include a conductive material and/or a binder if desired. As the conductive material and/or binder, one or more of the components of the conductive material and/or binder applicable to the above-described positive electrode active material layer 121b may be used, but an example embodiment thereof is not limited thereto.

In another example in the example embodiment, the negative electrode active material layer 122b of the solid-state battery 100 may further include a solid electrolyte component if desired. As the solid electrolyte component, one or more of the components of the above-described solid electrolyte may be used, and the solid electrolyte component may function as an ion conduction channel in the negative electrode active material layer 122b. Accordingly, interface resistance may be reduced.

In an example embodiment, the average thickness of the negative electrode active material layer 122b of the solid-state battery 100 in the example embodiment may be 5.0 μm or less. The average thickness of the negative active material layer 122b may be 5.0 μm or less, 4.8 m or less, 4.6 μm or less, 4.4 μm or less, 4.2 μm or less, or 4.0 μm or less, but an example embodiment thereof is not limited thereto. A lower limit of the average thickness of the negative active material layer 122b is not limited to any particular example, and may be, for example, 0.5 μm or more.

The negative electrode layer 122 of the solid-state battery 100 in the example embodiment may include the negative electrode current collector 122a together with the negative electrode active material layer 122b. The negative electrode current collector 122a may include one or more of the components applicable to the above-described positive electrode current collector 121a, but an example embodiment thereof is not limited thereto.

The method of forming the negative electrode layer 122 is not limited to any particular method, and for example, slurry may be formed by mixing the above-described negative electrode active material, a conductive material (additionally including the solid electrolyte layer 111 if desired) and a binder, and the negative electrode layer 121 may be formed by casting the slurry on the negative electrode current collector 121a and curing the slurry.

In an example embodiment, the average thickness t_{b1} of the positive active material layer 121b of the solid-state battery 100 in the example embodiment and the average thickness t_{b2} of the negative active material layer 122b may satisfy t_{b1}>_{tb2}. That is, the average thickness t_{b1} of the positive electrode active material layer 121b of the solid-state battery 100 in the example embodiment may be greater than the average thickness t_{b2} of the negative electrode active material layer 122b. The positive active material layer 121b and the negative active material layer 122b of the solid-state battery 100 in the example embodiment may include the above-described components, and as described above, when the average thickness t_{b1} of the positive active material layer 121b is configured to be greater than the average thickness t_{b2} of the negative electrode active material layer 122b, solid-state battery 100 having high current properties may be implemented.

In the above embodiment, the average thickness t_{b1} of the positive active material layer 121b of the solid-state battery 100 in the example embodiment and the average thickness t_{b2} of the negative active material layer 122b may satisfy t_{b1}≥2.5×t_{b2}. That is, in the solid-state battery 100 in the example embodiment, the average thickness t_{b1} of the positive active material layer 121b may be 2.5 times or more the average thickness t_{b2} of the negative active material layer 122b. The average thickness t_{b1} of the positive electrode active material layer 121b may be 2.5×t_{b2} or more, 2.6×t_{b2} or more, 2.7×t_{b2}, or more, 2.8×t_{b2} or more, 2.9×t_{b2} or more, or 3.0×t_{b2} or more, and an upper limit is limited to any particular example, but, may be, for example, 20×t_{b2} or less. When the average thickness t_{b2} of the positive electrode active material layer 121b and the average thickness t_{b1} of the negative electrode active material layer 122b of the solid-state battery 100 in the example embodiment satisfy the above ranges, the solid-state battery 100 having high current properties and high capacity electricity may be provided.

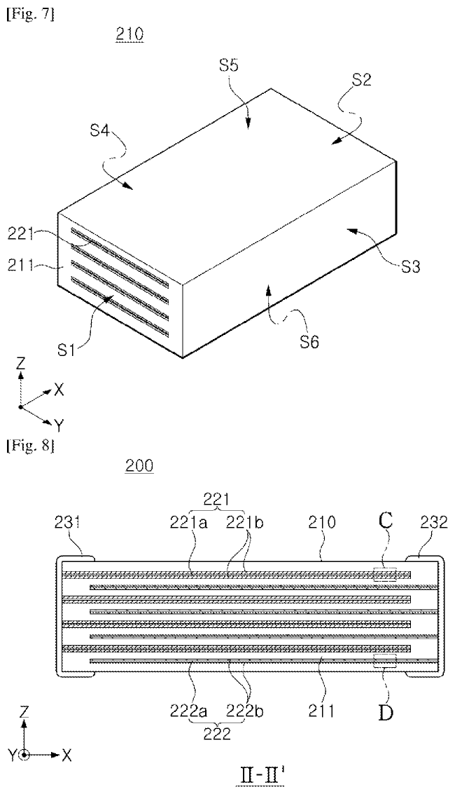

In another example in the example embodiment, a battery body 210 of a solid-state battery 200 in the example embodiment may include a plurality of positive electrode layers 221 and/or a plurality of negative electrode layers 222. FIGS. 6 to 10 are diagrams illustrating the solid-state battery 200 according to an example embodiment. Referring to FIGS. 6 to 10, the solid-state battery 200 in the example embodiment may include two or more positive electrode layers 221 and two or more negative electrode layers 222, and the plurality of positive electrode layers 221 and the plurality of negative electrode layers 222 may be alternately stacked with the solid electrolyte layer 211 interposed therebetween. When the plurality of positive electrode layers 221 and/or the plurality of negative electrode layers 222 are disposed as in the example, a high charging/discharging rate and high capacity may be implemented.

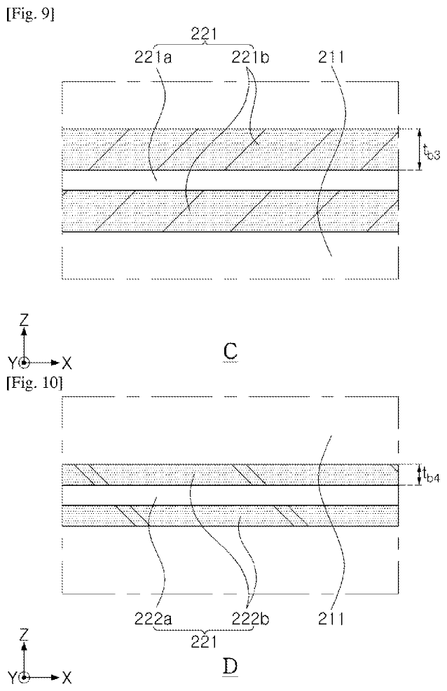

In the above example embodiment, in the positive electrode layer 221 of the solid-state battery 200 in the example embodiment, a positive electrode active material layers 221b may be disposed on both surfaces in the third direction with the positive electrode current collector 221a interposed therebetween. That is, in the solid-state battery 200 in the example embodiment, the positive electrode active material layers 221b may be disposed on both surfaces of the positive electrode current collector 221a in the third direction. Referring to FIGS. 8 and 9, the positive electrode active material layer 221b may be disposed to oppose the positive electrode current collector 221a in the third direction. As for the positive electrode layer 221 disposed on the outermost side in the third direction in the above structure, the positive electrode active material layer 221b may be disposed on only one surface of the positive electrode current collector 221a, and for example, the positive active material layer 221b may not be disposed in the direction in which the negative electrode layer 222 is not disposed, and the positive active material layer 221b may be disposed only in the direction in which the negative electrode layer 222 is disposed, but an example embodiment thereof is not limited thereto.

In the above example, in the negative electrode layer 222 of the solid-state battery 200 in the example embodiment, the negative electrode active material layers 222b may be disposed on both surfaces in the third direction with the negative electrode current collector 222a interposed therebetween. That is, in the solid-state battery 200 in the example embodiment, the negative electrode active material layers 222b may be disposed on both surfaces of the negative electrode current collector 222a in the third direction. Referring to FIGS. 8 and 10, the negative electrode active material layer 222b may be disposed to oppose the negative electrode current collector 222a in the third direction. As for the negative electrode layer 222 disposed on the outermost side in the third direction in the above structure, the negative active material layer 222b may be disposed on only one surface of the negative electrode current collector 222a, and for example, the negative active material layer 222b may not be disposed in the direction in which the positive electrode layer 221 is not disposed, and the negative active material layer 222b may be disposed only in the direction in which the positive electrode layer 221 is disposed, but an example embodiment thereof is not limited thereto.

The descriptions of the positive electrode active material, the positive electrode current collector, solid electrolyte, the negative electrode active material, and the negative electrode current collector are the same as in the aforementioned example embodiment, and will thus not be provided.

In an example embodiment, the average thickness t_{b3} of the positive active material layer 221b of the solid-state battery 200 in the example embodiment and the average thickness t_{b4} of the negative active material layer 222b may satisfy t_{b3}>_{tb4}. That is, the average thickness t_{b3} of the positive electrode active material layer 221b of the solid-state battery 200 in the example embodiment may be greater than the average thickness t_{b4} of the negative electrode active material layer 222b. The positive active material layer 221b and the negative active material layer 222b of the solid-state battery 200 in the example embodiment may include the above-described components, and as described above, when the average thickness t_{b3} of the positive active material layer 221b is configured to be greater than the average thickness ty of the negative electrode active material layer 222b, solid-state battery 200 having high current properties may be implemented.

In the above embodiment, the average thickness t_{b4} of the positive active material layer 221b of the solid-state battery 200 in the example embodiment and the average thickness t_{b4} of the negative active material layer 222b may satisfy t_{b3}≥2.5×t_{b4}. That is, in the solid-state battery 100 in the example embodiment, the average thickness t_{b3} of the positive active material layer 221b may be 2.5 times or more the average thickness t_{b4} of the negative active material layer 222b The average thickness t_{b3} of the positive electrode active material layer 221b may be 2.5×t_{b4} or more, 2.6×t_{b4} or more, 2.7×t_{b4} or more. 2.8×t_{b4} or more, 2.9×t_{b4} or more, or 3.0×t_{b4} or more, and an upper limit is limited to any particular example, but, may be, for example, 20×t_{b4} or less. When the average thickness t_{b3} of the positive electrode active material layer 221b and the average thickness t_{b4} of the negative electrode active material layer 222b of the solid-state battery 200 in the example embodiment satisfy the above ranges, the solid-state battery 200 having high current properties and high capacity electricity may be provided.

The solid-state battery 100, 200 in the example embodiment may include positive electrode terminals 131 and 231 connected to the positive electrode layers 121 and 221 and disposed on the first surface of the battery body 210, and negative terminals 132 and 232 connected to the negative electrode layers 221 and 222 and disposed on the second surface of the battery body 110.

The positive terminals 131 and 231 and the negative terminals 132 and 232 may be formed by, for example, applying the paste for a terminal electrode including a conductive metal on lead-out portions of the positive electrode layers 121 and 221 and the negative electrode layers 122 and 222, or by applying the paste or powder for a terminal electrode on the positive electrode layers 121 and 221, and the negative electrode layers 122 and 222 of the sintered battery body 110 and 210, and baking the paste or powder by induction heating. The conductive metal may be one or more of copper (Cu), nickel (Ni), tin (Sn), palladium (Pd), platinum (Pt), gold (Au), silver (Ag), tungsten (W), titanium (Ti), lead (Pb), and alloys thereof, but an example embodiment thereof is not limited thereto.

In an example embodiment, the solid-state batteries 100 and 200 in the example embodiment may further include plating layers (not illustrated) disposed on the positive terminals 131 and 231 and the negative terminals 132 and 232, respectively. The plating layer may include one or more elements selected from a group consisting of copper (Cu), nickel (Ni), tin (Sn), palladium (Pd), platinum (Pt), gold (Au), silver (Ag), tungsten (W), titanium (Ti), lead (Pb) and alloys thereof, but an example embodiment thereof is not limited thereto. A single plating layer or a plurality of the plating layers may be provided, and the plating layer may be formed by sputtering or electric deposition, but an example embodiment thereof is not limited thereto.

According to the aforementioned example embodiments, a solid-state battery having excellent stability in a charge-discharge cycle may be provided.

Also, a solid-state battery having a high operating voltage may be provided.

Further, a solid-state battery having improved long-term reliability may be provided.

While the example embodiments have been illustrated and described above, it will be apparent to those skilled in the art that modifications and variations could be made without departing from the scope of the present disclosure as defined by the appended claims.

1. A solid-state battery, comprising:
a battery body including first and second surfaces opposing in a first direction of the battery body, third and fourth surfaces opposing in a second direction of the battery body, and fifth and sixth surfaces opposing in a third direction of the battery body, and having a positive electrode layer including a positive electrode current collector and a positive electrode active material layer, a solid electrolyte layer, and a negative electrode layer including a negative electrode current collector and a negative electrode active material layer;
a positive terminal connected to the positive electrode layer and disposed on the first surface of the battery body; and
a negative terminal connected to the negative electrode layer and disposed on the second surface of the battery body,
wherein the positive active material layer includes lithium cobalt phosphate (LCP),
wherein the solid electrolyte layer includes a lithium aluminum germanium phosphate (LAGP) solid electrolyte represented as Li₁₊ₓAlₓ Ge₂₋ₓ(PO₄)₃(0<x<1), and
wherein the negative electrode active material layer includes at least one or more of lithium germanium phosphate (LGP) and lithium tin phosphate (LSP).

2. The solid-state battery of claim 1, wherein lithium cobalt phosphate (LCP) includes LiCoPO₄.

3. The solid-state battery of claim 1, wherein an average thickness of the solid electrolyte layer is in a range of 3 μm to 30 μm.

4. The solid-state battery of claim 1, wherein an average thickness, defined as t_{b1}, of the positive active material layer and an average thickness, defined as t_{b2} of the negative active material layer satisfy t_{b1}>_{tb2}.

5. The solid-state battery of claim 1, wherein an average thickness, defined as t_{b1}, of the positive active material layer and an average thickness, defined as t_{b2}, of the negative active material layer satisfy t_{b1}≥2.5×t_{b2}.

6. The solid-state battery of claim 1, wherein an operating voltage of the solid-state battery is 3.5V or higher.

7. A solid-state battery, comprising:
a battery body including first and second surfaces opposing in a first direction of the battery body, third and fourth surfaces opposing in a second direction of the battery body, and fifth and sixth surfaces opposing in a third direction of the battery body, and having a positive electrode layer including a positive electrode current collector and a positive electrode active material layer, a solid electrolyte layer, and a negative electrode layer including a negative electrode current collector and a negative electrode active material layer;
a positive terminal connected to the positive electrode layer and disposed on the first surface of the battery body; and
a negative terminal connected to the negative electrode layer and disposed on the second surface of the battery body,
wherein the positive active material layer includes lithium cobalt phosphate (LCP), and
wherein an operating voltage of the solid-state battery is 3.5 V or higher.

8. The solid-state battery of claim 7, wherein lithium cobalt phosphate (LCP) includes LiCoPO₄.

9. The solid-state battery of claim 7, wherein an average thickness of the positive active material layer is 5.0 μm or less.

10. The solid-state battery of claim 7, wherein the solid electrolyte layer includes a NASICON-type solid electrolyte.

11. The solid-state battery of claim 7, wherein an average thickness of the solid electrolyte layer is in a range of 3 μm to 30 μm.

12. The solid-state battery of claim 7, wherein an average thickness of the negative electrode active material layer is 5.0 ™ or less.

13. The solid-state battery of claim 7, wherein an average thickness, defined as t_{b1}, of the positive active material layer and an average thickness, defined as t_{b2}, of the negative active material layer satisfy t_{b1}>_{tb}2.

14. The solid-state battery of claim 7, wherein an average thickness, defined as t_{b1}, of the positive active material layer and an average thickness, defined as t_{b2}, of the negative active material layer satisfy t_{b1}≥2.5×t_{b2}.

15. The solid-state battery of claim 7, wherein the battery body includes a plurality of the positive electrode layers and a plurality of the negative electrode layers.

16. The solid-state battery of claim 15, wherein the plurality of the positive electrode layers and the plurality of the negative electrode layers are alternately stacked.

17. A solid-state battery, comprising:
a battery body including a positive electrode layer including a positive electrode current collector and a positive electrode active material layer, a negative electrode layer including a negative electrode current collector and a negative electrode active material layer, and a solid electrolyte layer disposed between the positive electrode layer and the negative electrode layer;
a positive terminal disposed on the battery body and connected to the positive electrode layer; and
a negative terminal disposed on the battery body and connected to the negative electrode layer,
wherein the solid electrolyte layer includes a lithium aluminum germanium phosphate (LAGP) solid electrolyte represented as Li₁₊ₓAlₓ Ge₂₋ₓ(PO₄)₃(0<x<1), and
wherein the negative electrode active material layer includes at least one or more of lithium germanium phosphate (LGP) and lithium tin phosphate (LSP).

18. The solid-state battery of claim 17, wherein the positive electrode active material layer includes LiCoPO₄.

19. The solid-state battery of claim 17, wherein an average thickness of the positive active material layer is 5.0 μm or less.

20. The solid-state battery of claim 17, wherein an average thickness of the solid electrolyte layer is in a range of 3 μm to 30 μm.

21. The solid-state battery of claim 17, wherein an average thickness, defined as t_{b1}, of the positive active material layer and an average thickness, defined as t_{b2}, of the negative active material layer satisfy t_{b1}>_{tb}2.

22. The solid-state battery of claim 21, wherein t_{b1}>2.5×t_{b2}.
